(19) United States
(12) Patent Application Publication
(10) Pub. No.: US 2019/0078511 A1
(43) Pub. Date: Mar. 14, 2019

(54) CONTROL METHOD FOR INTERNAL COMBUSTION ENGINE AND CONTROL DEVICE FOR INTERNAL COMBUSTION ENGINE

(71) Applicant: NISSAN MOTOR CO., LTD., Yokohama-shi, Kanagawa (JP)

(72) Inventors: Eiji TAKAHASHI, Kanagawa (JP); Kazuhiko OKAMOTO, Kanagawa (JP)

(73) Assignee: NISSAN MOTOR CO., LTD., Yokohama-shi, Kanagawa (JP)

(21) Appl. No.: 16/083,575

(22) PCT Filed: Nov. 16, 2016
(86) PCT No.: PCT/JP2016/083892

§ 371 Date: Sep. 10, 2018

(30) Foreign Application Priority Data
Mar. 11, 2016 (JP) 2016-047768

(51) Int. Cl. F02B 75/04; F02D 15/02

(52) U.S. Cl. CPC F02B 75/048; F02D 2700/05; F02D 2700/03; F02D 15/02

(57) ABSTRACT

A control method for an internal combustion engine which includes a variable compression ratio mechanism: controlling the compression ratio by using a control target compression ratio whose a variation amount per unit time is limited to be equal to or smaller than a predetermined variation amount threshold value; and setting a first variation amount threshold value which is the variation amount threshold value of the control target compression ratio per unit time toward a high compression ratio side, to be smaller than a second variation amount threshold value which is the variation amount threshold value of the control target compression ratio per unit time toward a low compression ratio side.

### TECHNICAL FIELD

This invention relates to a control method for an internal combustion engine arranged to vary a compression ratio, and a control device for an internal combustion engine arranged to vary a compression ratio.

### BACKGROUND ART

For example, patent documents 1 and 2 disclose an art to limit a variation amount of a target compression ratio when a compression ratio is varied in an internal combustion engine arranged to vary a compression ratio, and thereby to avoid a sudden torque variation and a deterioration of a traveling performance.

In this case, when a drive in which a depression release of an accelerator pedal is repeated is performed, the target compression ratio is varied due to a variation of the load. That is, the target compression ratio is repeatedly decreased and increased from a high compression ratio to a low compression ratio, and from the low compression ratio to the high compression ratio. At this time, when the variation amount of the target compression ratio is limited as disclosed in the patent documents 1 and 2, a deviation between the target compression ratio and the actual compression ratio is suppressed. Accordingly, it is possible to decrease a power consumption of a motor arranged to drive a variable compression ratio mechanism.

Moreover, in a case where the variable compression ratio mechanism is a multi-link piston crank mechanism constituted by a plurality of links linking a piston and a crank shaft, a combustion load is acted in a direction pressing the piston in a downward direction. Accordingly, a response speed at the variation of the compression ratio toward the low compression ratio side is higher than a response speed at the variation of the compression ratio toward the high compression ratio side. In this way, in a case where the response speed of the variable compression ratio mechanism at the variation toward the low compression ratio side is different from the response speed of the variable compression ratio mechanism at the variation toward the high compression ratio side, for example, when the variation amount of the target compression ratio is limited in accordance with the high compression ratio side in which the response speed is lower, the variation toward the low compression ratio side is limited with respect to the normally variable amount.

Consequently, the response is deteriorated.

### PRIOR ART DOCUMENT

### Patent Document

Patent Document 1: Japanese Patent Application Publication No. 2013-79607

Patent Document 2: Japanese Patent Application Publication No. 2005-9366

### SUMMARY OF THE INVENTION

In the present invention, a control method for an internal combustion engine including a variable compression ratio mechanism which is a multi-link piston crank mechanism arranged to vary a compression ratio, the control method includes a response speed toward a low compression ratio side being set to be higher than a response speed toward a high compression ratio side.

In the present invention, the variation toward the low compression ratio side is varied at the response speed higher than that of the high compression ratio side, without corresponding to the response speed of the high compression ratio side. Accordingly, it is possible to suppress the deterioration.

### BRIEF DESCRIPTION OF DRAWINGS

FIG. 1 is an explanation view schematically showing an internal combustion engine to which the present invention is applied.

FIG. 2 is an explanation view schematically showing a driving source of a variable compression ratio mechanism to which the present invention is applied.

FIG. 3 is a time chart showing one example in a case where the variable compression ratio mechanism is controlled without consideration of a limitation of a followability of an actual compression ratio with respect to a target value.

FIG. 4 is a flowchart showing a flow of a control of an internal combustion engine according to the present invention.

FIG. 5 is an explanation view showing an outline of a map used in a calculation of a first variation amount threshold value.

FIG. 6 is an explanation view showing an outline of a map used in a calculation of a second variation amount threshold value.

FIG. 7 is a timing chart showing one example in a case where the variable compression ratio mechanism is controlled with consideration of the limitation of the followability of the actual compression ratio with respect to the target value.

### DESCRIPTION OF EMBODIMENTS

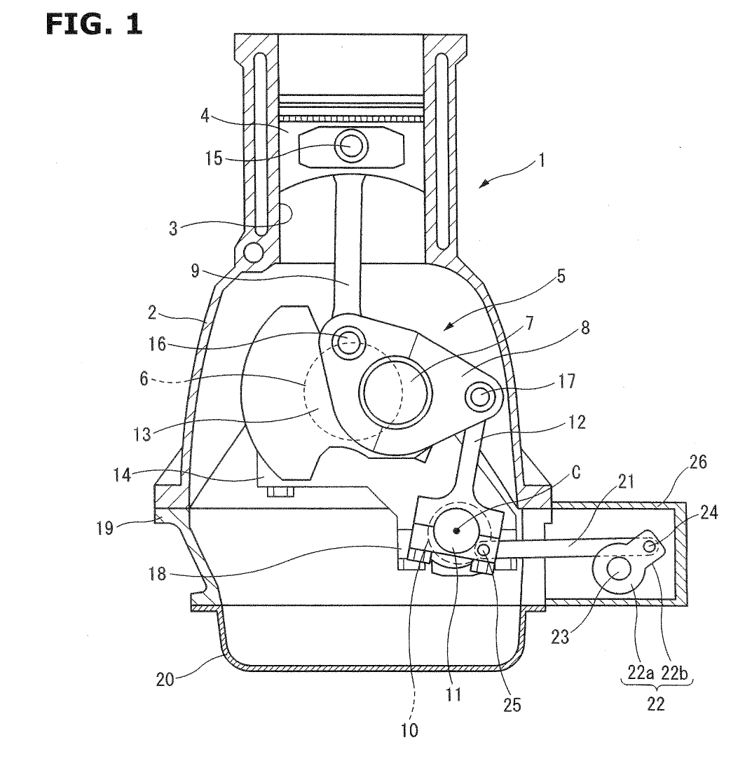

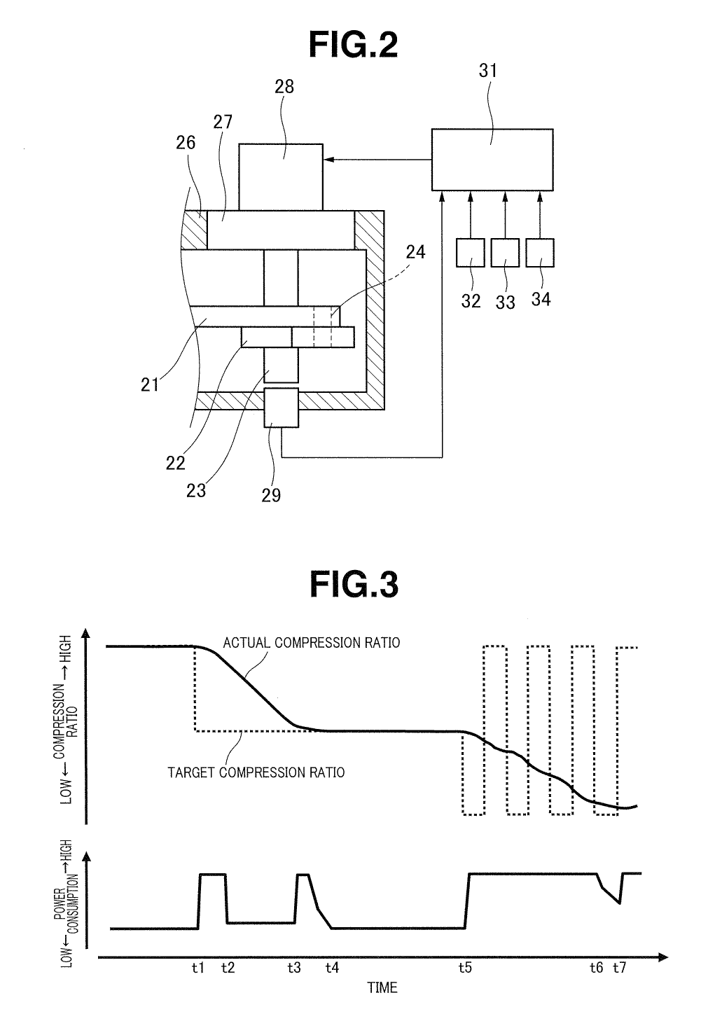

Hereinafter, one embodiment according to the present invention is explained in detail with reference to drawings. FIG. 1 is an explanation view schematically showing a schematic configuration of an internal combustion engine 1 to which the present invention is applied. FIG. 2 is an explanation view schematically showing a schematic configuration of a driving source of a variable compression ratio mechanism 5 of the Internal combustion engine 1 to which the present invention is applied.

As shown in FIG. 1, the internal combustion engine 1 includes a variable compression ratio mechanism 5 arranged to vary an upper dead center position of a piston 4 reciprocated within a cylinder 3 of a cylinder block 2 constituting an engine main body, and thereby to vary an engine compression ratio.

The variable compression ratio mechanism 5 is a multi-link piston crank mechanism in which the piston 4, and a crank pin 7 of a crank shaft 6 are linked by a plurality of links. The variable compression ratio mechanism 5 includes a lower link 8 rotatably mounted to a crank pin 7; an upper link 9 connecting this lower link 8 and the piston 4; a control shaft 10 including an eccentric shaft portion 11; and a control link 12 connecting the eccentric shaft portion 11 and the lower link 8.

The crank shaft 6 includes a plurality of journal portions 13 and the crank pin 7. Each of the journal portions 13 is rotatably supported between the cylinder block 2 and a crank bearing bracket 14.

The upper link 9 includes one end rotatably mounted to a piston pin 15; and the other end rotatably connected to the lower link 8 by a first link pin 16. The control link 12 includes one end rotatably connected to the lower link 8 by a second link pin 17; and the other end rotatably mounted to the eccentric shaft portion 11 of the control shaft 10. Each of the first link pin 16 and the second link pin 17 is fixed to the lower link 8 by the press-fit.

The control shaft 10 is disposed in parallel to the crank shaft 6. Moreover, the control shaft 10 is rotatably supported by the cylinder block 2. Specifically, the control shaft 10 is rotatably supported between the crank bearing 2s bracket 14 and a control shaft bearing bracket 18.

An upper oil pan 19 is mounted to a lower portion of the cylinder block 2. Moreover, a lower oil pan 20 is mounted to a lower portion of the upper oil pan 19.

A rotation of a drive shaft 23 is transmitted through an actuator link 21 and a drive shaft arm member 22 to the control shaft 10. The drive shaft 23 is disposed outside the upper oil pan 19 in parallel with the control shaft 10. The drive shaft arm member 22 is fixed to the drive shaft 23 by the press fit. The drive shaft arm member 22 includes a cylindrical base portion 22a which is press-fit on the drive shaft 23; and an arm portion 22b extending from the base portion 22a in a radially outside direction of the base portion. One end of the actuator link 21 is rotatably connected thorough a pin member 24 to the arm portion 22b of the drive shaft arm member 22. The actuator link 21 is an elongated rod-shaped member disposed to be perpendicular to the control shaft 10. The actuator link 21 includes the other end rotatably connected through a pin member 25 to the control shaft 10 at a position which is offset from a rotation center of the control shaft 10.

The drive shaft 23, the drive shaft arm member 22, and the one end side of the actuator link 21 are received within a housing 26 mounted to a side surface of the upper oil pan 19.

As shown in FIG. 2, the drive shaft 23 includes one end connected through a speed reduction device 27 to an electric motor 28. That is, the drive shaft 23 is arranged to be drivingly rotated by the electric motor 28. A rotation speed of the drive shaft 23 is obtained by decreasing the rotation speed of the electric motor 28 by the speed reduction device 27.

When the drive shaft 23 is rotated by the drive of the electric motor 28, the actuator link 21 is reciprocated along a plane perpendicular to the drive shaft 23. Then, the connection position between the other end of the actuator link 21 and the control shaft 10 is swung in accordance with the reciprocating movement of the actuator link 21, so that the control shaft 10 is rotated. The rotation position of the control shaft 10 is varied by the rotation of the control shaft 10, so as to vary the position of the eccentric shaft portion 11 which is a swing fulcrum point of the control link 12. That is, a posture of the lower link 8 is varied by varying the rotation position of the control shaft 10 by the electric motor 28, so that a compression ratio of the Internal combustion engine 1 is continuously varied with a piston motion (stroke characteristics) of the piston 4, that is, variations of the upper dead center position and a lower dead center position of the piston 4.

The electric motor 28 is mounted to a rear end side of the housing 26. A rotation angle sensor 29 is mounted to a front end side of the housing 26. The rotation angle sensor 29 is arranged to sense a rotation angle of the drive shaft 23.

A detection signal of the rotation angle sensor 29 is inputted to the control unit 31. The control unit 31 is a known digital computer including a CPU, a ROM, a RAM, and an input and output interface. The control unit 31 receives detection signals from various sensors such as an accelerator opening degree sensor 32 arranged to sense an accelerator pedal depression amount (accelerator opening degree APO) that represents a desired load state of the internal combustion engine 1, a crank angle sensor 33 arranged to sense the engine speed and the crank angle of the crank shaft 6, and an oil temperature sensor 34 arranged to sense an oil temperature of the internal combustion engine 1.

The control unit 31 is configured to output control signals to a fuel injection valve (not shown), an ignition plug (not shown), the electric motor 28 of the variable compression ratio mechanism 5, based on the signals inputted from these various sensors, and so on. The control unit 31 is configured to totally control a fuel injection amount, a fuel injection timing, an ignition timing, the engine speed, the compression ratio, and so on.

The above-described variable compression ratio mechanism 5 is a multi-link piston crank mechanism constituted by a plurality of links linking the piston 4 and the crank shaft 6. Accordingly, a combustion load is acted in a direction to push the piston 4 in a downward direction. Therefore, the variable compression ratio mechanism 5 is set so that a response speed of the variable compression ratio mechanism 5 at a variation of the compression ratio toward a low compression ratio side is higher than a response speed of the variable compression ratio mechanism 5 at a variation of the compression ratio toward a high compression ratio side. Accordingly, when the compression ratio is varied toward the low compression ratio side, the variable compression ratio mechanism 5 varies the compression ratio by the response speed higher than the response speed at the variation of the high compression ratio side, without corresponding to the response speed at the variation of the compression ratio toward the high compression ratio. Consequently, it is possible to suppress the deterioration of the response.

Moreover, when the compression ratio is varied in the internal combustion engine 1 including the variable compression ratio mechanism 5, there is a limit to a followabllity (response) of the actual compression ratio with respect to the target compression ratio. Accordingly, for example, when a large variation of the target compression ratio is continuously frequently performed, the actual compression ratio does not follow the target compression ratio, and the power consumption of the electric motor 28 arranged to drive the variable compression ratio mechanism 5 becomes large. This is because the power consumption of the electric motor 28 becomes higher as a deviation between the actual compression ratio and the target compression ratio is larger.

FIG. 3 is a timing chart showing one example (reference example) in which the variable compression ratio mechanism 5 is controlled without consideration of the limitation of the followability of the actual compression ratio with respect to the target value.

Before time t1, it is a steady state in which the compression ratio is maintained to a predetermined high compression ratio. Accordingly, the power consumption of the electric motor 28 becomes relatively small.

At time t1, the target compression ratio (a broken line in FIG. 3) is varied to a predetermined intermediate compression ratio. From time t1 to time t2 at which the electric motor 28 reaches a predetermined maximum rotation speed, the rotation speed of the electric motor 28 is increased. That is, from time t1 to time t2, the rotation speed of the electric motor 28 is accelerated. Accordingly, the electric motor 28 needs a large torque. Consequently, the power consumption of the electric motor 28 is relatively increased.

When the rotation speed of the electric motor 28 reaches the maximum rotation speed, the rotation speed of the electric motor 28 is maintained to the maximum rotation speed until t3 at which the actual compression ratio (a solid line in FIG. 3) gets close to the target compression ratio to some extent. That is, from time t2 to time t3, the rotation speed of the electric motor 28 becomes constant. The compression ratio is varied (toward the low compression ratio) in the substantially constant state of the rotation speed of the electric motor 28. Consequently, the power consumption of the electric rotor 28 becomes relatively small.

From time t3 to time t4, a difference between the actual compression ratio and the target compression ratio becomes small. The rotation speed of the electric motor 28 is decreased so that the actual compression ratio becomes smaller than the target compression ratio. Accordingly, the power consumption becomes relatively high.

From time t4 to time t5, the compression ratio is maintained to the low compression ratio. Accordingly, the power consumption of the electric motor 28 becomes relatively low.

After time t5, the large variation of the target compression ratio (the variation in which the value of the target compression ratio is largely varied) is repeatedly frequently performed. That is, the target compression ratio is varied from the intermediate compression ratio to the predetermined low compression ratio. Then, the target compression ratio is varied from the predetermined low compression ratio to the predetermined high compression ratio, or varied from the predetermined high compression ratio to the predetermined low compression ratio during a short time period. That is, after time t5, the target compression ratio is repeatedly frequently increased and decreased so that the actual compression ratio cannot follow the target compression ratio. Accordingly, after time t5, a state in which the difference between the target compression ratio and the actual compression ratio is large is continued. Consequently, a state where the rotation speed of the electric motor 28 is accelerated is continued during the long time period. Therefore, the power consumption of the electric motor 28 becomes relatively high. For example, when the depression release of the accelerator pedal is repeated, the target compression ratio is frequently repeatedly increased and decreased like after time t6.

Besides, from time t6 to time t7, the actual compression ratio gets close to the target compression ratio. Accordingly, the power consumption of the electric motor 28 temporarily becomes low.

In this way, when the variable compression ratio mechanism 5 is controlled without consideration of the limitation of the followability of the actual compression ratio to the target value, the large variation of the target compression ratio is repeatedly frequently performed, the large deviation state between the target compression ratio and the actual compression ratio is continued. Accordingly, the state where the rotation speed of the electric motor 28 is accelerated or decelerated is continued, so that the power consumption is increased.

Therefore, in this embodiment, the compression ratio is controlled with consideration of the limitation of the followability of the actual compression ratio to the target value.

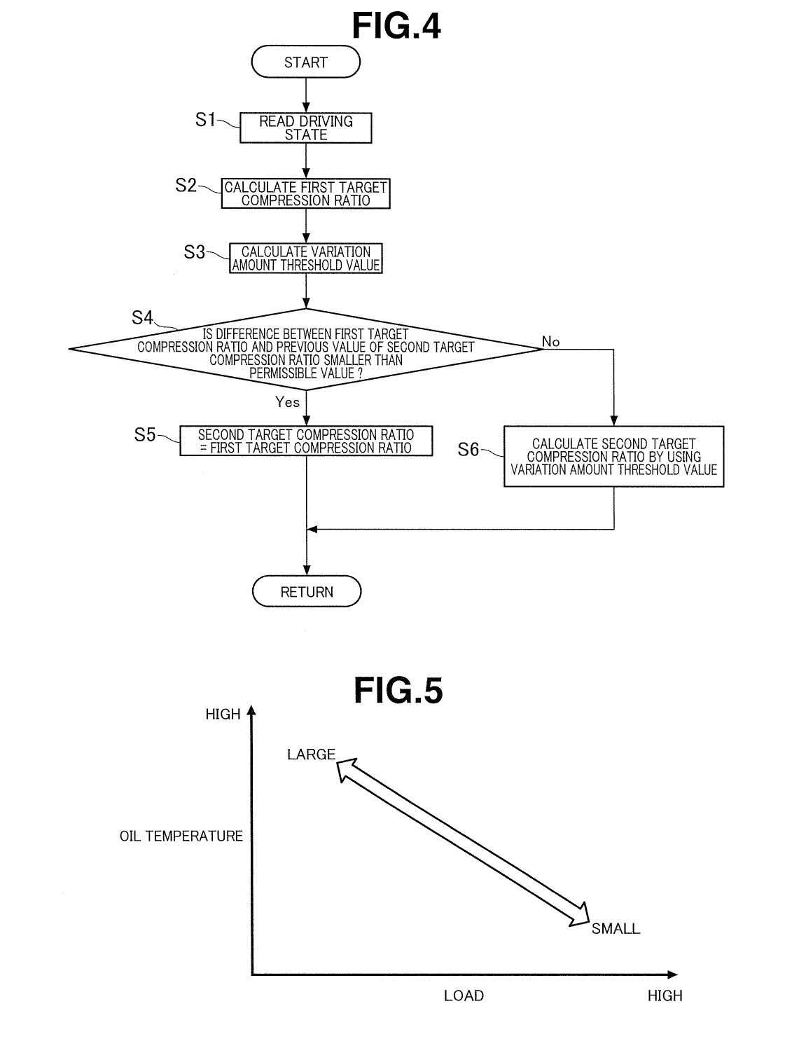

FIG. 4 is a flowchart showing a flow of the control of the internal combustion engine 1 according to the present invention. At S1, a driving state of the internal combustion engine 1 is read. Specifically, the engine speed, the load (the throttle opening degree), and the oil temperature of the engine 1 are read.

At S2, a first target compression ratio which is a basic target compression ratio is calculated based on the driving state. That is, the first target compression ratio is calculated from the engine speed and the load. In this embodiment, the control unit 31 stores a first target compression ratio calculation map (not shown) in which the first target compression ratio is assigned (allocated) in accordance with the engine speed and the load. The first target compression ratio is calculated based on the first target compression ratio calculation map.

At S3, a variation amount threshold value is calculated from the load and the oil temperature. The variation amount threshold value includes a first variation amount threshold value and a second variation amount threshold value. The first variation amount threshold value is a variation amount threshold value of the second target compression ratio (which is the control target compression ratio) per unit time toward the high compression ratio side. The second variation amount threshold value is a variation amount threshold value of the second target compression ratio (which is the control target compression ratio) per unit time toward the low compression ratio side.

In this embodiment, the control unit 31 stores the first variation amount threshold value calculation map in which the first variation amount threshold value is assigned (allocated) in accordance with the load and the oil temperature. The first variation amount threshold value is calculated based on the first variation amount threshold value calculation map. The first variation amount threshold value calculation map is set so that the calculated first variation amount threshold value is larger as the load is lower and the oil temperature is higher, as shown in FIG. 5. That is, the first variation amount threshold value calculation map is set so that the calculated first variation amount threshold value is smaller as the load is higher and the oil temperature is lower.

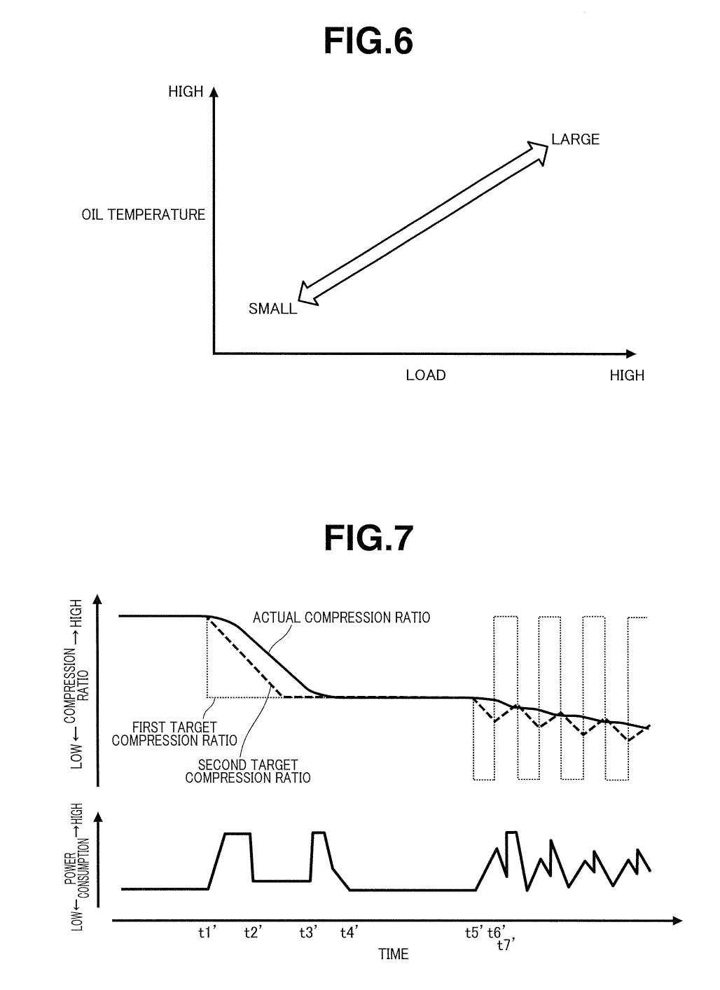

In this embodiment, the control unit 31 is stores a second variation amount threshold value calculation map in which the second variation amount threshold value is assigned (allocated) in accordance with the load and the oil temperature. The second variation amount threshold value is calculated based on the second variation amount threshold value calculation map. The second variation amount threshold value calculation map is set so that the calculated second variation amount threshold value is larger as the load is higher and the oil temperature is higher, as shown in FIG. 6. That is, the second variation amount threshold value calculation map is set so that the calculated second variation amount threshold value is smaller as the load is lower and the oil temperature is lower. Moreover, the second variation amount threshold value is set to be larger than the first variation amount threshold value in the same driving state.

At S4, it is judged whether or not a difference between the first target compression ratio and a previous value of the second target compression ratio is equal to or smaller than a predetermined permissible value. When it is equal to or smaller than the predetermined permissible value, the process proceeds to S5. When it is greater than the predetermined permissible value, the process proceeds to S6. In this case, the predetermined permissible value is the first variation amount threshold value when the compression ratio is varied in an increasing direction. The predetermined permissible value is the second variation amount threshold value when the compression ratio is varied in a decreasing direction.

At S5, the first target compression ratio is set to the second target compression ratio. At S6, the second target compression ratio is calculated by using the 2s variation amount threshold value. That is, when the compression ratio is varied in the increasing direction, a value obtained by adding the first variation amount threshold value to the previous value of the second target compression ratio is set to the second target compression ratio. When the compression ratio is varied in the decreasing direction, a value obtained by subtracting the second variation amount threshold value from the previous value of the second target compression ratio is set to the second target compression ratio. In this way, the variation amount of the second target compression ratio per unit time is limited to be equal to or smaller than the first variation amount threshold value, or to be equal to or smaller than the second variation amount threshold value.

The second target compression ratio becomes identical to the first target compression ratio in the steady state in which the first target compression ratio is identical to the actual compression ratio.

Besides, the control unit 31 calculates the first target compression ratio and the second target compression ratio. Accordingly, the control unit 31 corresponds to a first target compression ratio calculating section and a second target compression ratio calculating section. Moreover, the first target compression ratio calculating section is synonymous with the basic target compression ratio calculating section. The second target compression ratio calculating section is synonymous with a control target compression ratio calculating section.

FIG. 7 is a timing chart showing one example in a case where the variable compression ratio mechanism 5 is controlled with consideration of the limitation of the followability of the actual compression ratio to the target value. That is, FIG. 7 is a timing chart showing one example in a case where the variable compression ratio mechanism 5 is controlled by using the second target compression ratio whose the variation amount per unit time is limited.

Until time t1′, it is the steady state where the compression ratio is held to the predetermined high compression ratio. Accordingly, the power consumption of the electric motor 28 becomes relatively low.

At time t1′, the first target compression ratio (a thin broken line in FIG. 7) is varied to the predetermined intermediate compression ratio. The variable compression ratio mechanism 5 is controlled by using the second target compression ratio whose the variation amount from the previous value of the second target compression ratio (a broken line in FIG. 7) is limited by the second variation amount threshold value. Accordingly, the difference between the second target compression ratio and the actual compression ratio (a solid line in FIG. 7) becomes relatively small immediately after time t1′. The power consumption is gently increased relative to a case where the variable compression ratio mechanism 5 is controlled by using the first target compression ratio.

From t1′ to time t2′ at which the electric motor 28 reaches a predetermined maximum rotation speed, the rotation speed of the electric motor 28 is increased. That is, from time t1′ to time t2′, the rotation speed of the electric motor 28 is accelerated. The electric motor 28 needs the large torque. Accordingly, the power consumption of the electric motor 28 becomes relatively high.

When the rotation speed of the electric motor 28 reaches the maximum rotation speed, the rotation speed of the electric motor 28 is maintained to the maximum rotation speed until time t3′ at which the actual compression ratio gets closer to the target compression ratio to some extent. That is, from time t2′ to time t3′, the rotation speed of the electric motor 28 becomes constant. The compression ratio is varied (decreased) in a state where the rotation speed of the electric motor 28 is substantially constant. Accordingly, the power consumption of the electric motor 28 is relatively low.

From time t3′ to time t4′, the difference between the actual compression ratio and the second target compression ratio becomes small. The rotation speed of the electric motor 28 is decreased so that the actual compression ratio does not become smaller than the second target compression ratio. Accordingly, the power consumption of the electric motor 28 becomes relatively high.

Besides, in a case where the first target compression ratio is not varied until the actual compression ratio becomes identical to the first target compression ratio after the variation of the first target compression ratio, the power consumption of the electric motor 28 when the variable compression ratio mechanism 5 is controlled by the first target compression ratio is substantially identical to the power consumption of the electric motor 28 when the variable compression ratio mechanism 5 is controlled by the second target compression ratio. That is, when the compression ratio variation amount from time t1 to time t4 in FIG. 3 is substantially identical to the compression ratio variation amount from time t1′ to time t4′ in FIG. 7, the power consumption of the electric motor 28 from time t1 to time t4 in FIG. 3 is substantially identical to the power consumption of the electric motor 28 from time t1′ to time t4′ in FIG. 7.

From time t4′ to time t5′, the compression ratio is held to the low compression ratio. Accordingly, the power consumption of the electric motor 28 becomes relatively low.

After time t5′, the large variation of the target compression ratio is repeatedly frequently performed. That is, the first target compression ratio is varied from the intermediate compression ratio to the predetermined low compression ratio. Then, the first target compression ratio is repeatedly varied from the predetermined low compression ratio to the predetermined high compression ratio, or varied from the predetermined high compression ratio to the predetermined low compression ratio during the short time period. That is, after time t5′, the first target compression ratio is repeatedly frequently increased or decreased in a manner that the actual compression ratio cannot follow the first target compression ratio.

However, in this embodiment, the variable compression ratio mechanism 5 is controlled by using the second target compression ratio whose the variation amount per unit time is limited. Accordingly, after time t5′, it is possible to relatively decrease the difference between the second target compression ratio and the actual compression ratio. Consequently, the variable compression ratio mechanism 5 can decrease the power consumption of the electric motor 28, relative to a case where the variable compression ratio mechanism 5 is controlled by using the first target compression ratio.

That is, the second target compression ratio from time t5′ to time t6′ is higher than the first target compression ratio during time t5′ to time t6′. With this, the actual compression ratio is easy to follow the second target compression ratio. Accordingly, it is possible to suppress the power consumption of the electric motor 28 relative to a case where the variable compression ratio mechanism 5 is controlled by using the first target compression ratio. The second target compression ratio from time t5′ to time t6′ is limited so that the variation amount from the previous value of the second target compression ratio becomes the second variation amount threshold value.

Moreover, the second target compression ratio from time t6′ to time t7′ is lower than the first target compression ratio during time t6′ to time t7′. Accordingly, the actual compression ratio is easy to follow the second target compression ratio. Consequently, it is possible to suppress the power consumption of the electric motor 28 relative to a case where the variable compression ratio mechanism 5 is controlled by using the first target compression ratio. The second target compression ratio from time t6′ to time t7′ is limited so that the variation amount from the previous value of the second target compression ratio becomes the first variation amount threshold value.

In this embodiment, the first variation amount threshold value and the second variation amount threshold value which are used at the calculation of the second target compression ratio are set to be different from each other. That is, the first variation amount threshold value and the second variation amount threshold value are set so that the limitation value of the variation amount of the second target compression ratio per unit time at the variation of the compression ratio to the high compression ratio side is different from the limitation value of the variation amount of the second target compression ratio per unit time at the variation of the compression ratio to the low compression ratio side.

Accordingly, the second target compression ratio can be set without excessive limitation of the variation amount per unit time. That is, the second target compression ratio can be set in accordance with the case where the compression ratio is varied to the high compression ratio side, and the case where the compression ratio is varied to the low compression ratio side. Consequently, it is possible to decrease the power consumption of the motor arranged to drive the variable compression ratio mechanism 5 while suppressing the deterioration of the response of the variable compression ratio mechanism 5.

Moreover, the second variation amount threshold value is set to be greater than the first variation amount threshold value. With this, it is possible to suppress the deterioration of the response of the variable compression ratio mechanism 5 at the variation of the compression ratio toward the low compression ratio.

The in-cylinder pressure is higher as the load of the internal combustion engine 1 is higher, so that the force acted to the piston 4 (the force pressing the piston 4) becomes relatively large. That is, the force acted to the variable compression ratio mechanism 5 to vary the compression ratio toward the lower compression ratio side becomes relatively large. Accordingly, the variable compression ratio mechanism 5 is hard to vary the compression ratio to the high compression ratio side. The response speed at the variation of the compression ratio toward the high compression ratio side is relatively decreased.

Accordingly, the first variation amount threshold value is set to be smaller as the load of the internal combustion engine 1 is higher. With this, the second target compression ratio can be a further actually followable target value. It is possible to further suppress the power consumption of the electric motor 28 arranged to drive the variable compression ratio mechanism 5.

Moreover, the second variation amount threshold value is set to be larger as the load of the internal combustion engine 1 is higher. With this, the second target compression ratio can be a further actually followable target value. With this, it is possible to suppress the unnecessary limitation of the response (the response speed) of the variable compression ratio mechanism 5 by unnecessarily decreasing the second variation amount threshold value.

A viscosity of the oil is higher as the oil temperature of the internal combustion engine 1 is lower. The response speed of the variable compression ratio mechanism 5 at the variation of the compression ratio is decreased.

Accordingly, the first variation amount threshold value and the second variation amount threshold value are set to be smaller as the oil temperature of the internal combustion engine 1 is lower. With this, the second target compression ratio can be a further actually followable target value. It is possible to further suppress the power consumption of the electric motor 28 arranged to drive the variable compression ratio mechanism 5.

Besides, in the above-described embodiment, the first variation amount threshold value and the second variation amount threshold value are varied in accordance with the driving state. However, one of the first variation amount threshold value and the second variation amount threshold value may be varied in accordance with the driving state. The other of the first variation amount threshold value and the second variation amount threshold value may be fixed to a predetermined value previously set independently of the driving state. In this case, the second target compression ratio becomes an actually followable target value relative to the first target compression ratio. Accordingly, the variable compression ratio mechanism 5 can decrease the power consumption of the motor 28 at the transition, relative to the control by using the first target compression ratio.

Moreover, the above-described embodiment relates to a control method and a control device for the internal combustion engine 1.

1: A control method for an internal combustion engine which includes a variable compression ratio mechanism which is arranged to vary a compression ratio, and in which a target compression ratio is varied at the variation of the compression ratio so that an actual compression ratio cannot follow the target compression ratio, the control method comprising:
controlling the compression ratio by using a control target compression ratio whose a variation amount per unit time is limited to be equal to or smaller than a predetermined variation amount threshold value, and which is varied so that a difference between the control target compression ratio and the actual compression ratio is smaller than a difference between the target compression ratio and the actual compression ratio, in place of the target compression ratio; and
setting a first variation amount threshold value which is the variation amount threshold value of the control target compression ratio toward a high compression ratio side, to be smaller than a second variation amount threshold value which is the variation amount threshold value of the control target compression ratio toward a low compression ratio side.

2-3. (canceled)

4: The control method for the internal combustion engine as claimed in claim 1, wherein the first variation amount threshold value is set to be smaller as a load of the internal combustion engine is higher.

5: The control method for the internal combustion engine as claimed in claim 1, wherein the second variation amount threshold value is set to be greater as a load of the internal combustion engine is higher.

6: The control method for the internal combustion engine as claimed in claim 1, wherein at least one of the first variation amount threshold value and the second variation amount threshold value is varied based on a driving state of the internal combustion engine.

7: The control method for the internal combustion engine as claimed in claim 1, wherein the first variation amount threshold value and the second variation amount threshold value are set to be smaller as an oil temperature of the internal combustion engine is lower.

8: The control method for the internal combustion engine as claimed in claim 1, wherein the control target compression ratio is limited so that a difference between a previous value of the control target compression ratio and ratio and a basic target compression ratio calculated based on a driving state of the internal combustion engine is equal to or smaller than the variation amount threshold value.

9: A control device for an internal combustion engine in which a target compression ratio is varied at a variation of a compression ratio so that an actual compression ratio cannot follow the target compression ratio, the control device comprising;
a control target compression ratio calculating section configured to calculate a control target compression ratio whose a variation amount per unit time is limited to be equal to or smaller than a variation amount threshold value, and which is varied so that a difference between the control target compression ratio and the actual compression ratio is smaller than a difference between the target compression ratio and the actual compression ratio, in place of the target compression ratio; and
a variable compression ratio mechanism arranged to vary the compression ratio of the internal combustion engine by using the control target compression ratio,
a first variation amount threshold value which is the variation amount threshold value of the control target compression ratio per unit time toward a high compression ratio side, and which is set to be smaller than a second variation amount threshold value that is the variation amount threshold value of the control target compression ratio per unit time toward a low compression ratio side.
